(19) United States
(12) Patent Application Publication
(10) Pub. No.: US 2011/0235715 A1
(43) Pub. Date: Sep. 29, 2011

(54) VIDEO CODING SYSTEM AND CIRCUIT EMPHASIZING VISUAL PERCEPTION

(75) Inventors: Shao-Yi Chien, Taipei (TW); Tung-Hsing Wu, Taipei (TW); Guan-Lin Wu, Taipei (TW)

(73) Assignee: VATICS INC., New Taipai City (TW)

(21) Appl. No.: 13/073,752

(22) Filed: Mar. 28, 2011

(30) Foreign Application Priority Data
Mar. 29, 2010 (TW) 099109293

(51) Int. Cl. H04N 7/12

(52) U.S. Cl. 375/240.16; 375/240.12; 375/E07.243; 375/E07.104

(57) ABSTRACT

A video coding system and circuit emphasizing visual perception are presented, which mainly include a video coding module and a video analysis module. A video frame is respectively input into the video coding module and the video analysis module. The video coding module performs a coding process on the input video frame, the video analysis module analyzes the input video frame to generate a quantization parameter adjustment value, and then the video coding module adjusts each coding parameter with the quantization parameter adjustment value. In this manner, a more efficient compression can be performed on the video frame, and the compressed video frame still maintains good image quality.

### CROSS-REFERENCE TO RELATED APPLICATIONS

This non-provisional application claims priority under 35 U.S.C. §119(a) on Patent Application No(s). 099109293 filed in Taiwan, R.O.C. on Mar. 29, 2010, the entire contents of which are hereby incorporated by reference.

### BACKGROUND OF THE INVENTION

1. Field of Invention

The present invention relates to a video coding system and circuit emphasizing visual perception, which efficiently compresses a video frame, and maintains the compressed video frame in a good image quality.

2. Related Art

With the coming of the digital age, the digitalization of images makes the storage and management of the images easier. However, the raw format of the digital images occupies quite a large storage space, so the data quantity of the digital images usually needs to be reduced through a video compression technology.

The principle of video compression is based on the similarities of images in time and space. The similar data are subjected to a compression algorithm process to extract the redundant information, which is removed to achieve the purpose of video compression.

In addition, to achieve better image compression quality, some existing video coding systems also take the parts perceived by human eyes into account to further reduce the information that cannot be perceived by human eyes, which is realized by the following common methods.

1. In a video coding system, a model taking a Just Noticeable Difference (JND) into consideration is introduced into the processing of prediction images, thereby improving the objective and subjective image quality. However, this method may increase the complexity in image prediction and cause the difficulty in practice, so the hardware architecture is difficult to implement.

2. A simple video analysis model is added to the input of existing video coding system as a side information provider. This method realizes the function of visual perception by making a minimal change to the architecture of the original video coding system. However, as the precision of adjustment parameters for image data obtained by the video analysis model is not high enough, after the video coding system performs coding on video frame with the adjustment parameters obtained under incomprehensive analysis conditions, coding parameters obtained by coding may fail to achieve predetermined goals of coding.

3. A video coding system of a new architecture design is proposed. This architecture is completely based on visual perception and is not limited to the conventional architecture. However, according to this method, the video coding system under the new architecture cannot be applied to a part of the architecture of the conventional video coding system, and the corresponding decoding system also needs to be redesigned. Therefore, the development cost of design is increased, and the hardware becomes incompatible with the conventional video coding system.

Therefore, in order to solve the above defects, the present invention provides a design of a video coding system taking visual perception into consideration based on the existing video coding system, which reduces the development time of the coding system, is easily implemented on the hardware architecture of the existing video coding system, and provides a good compression efficiency and maintains the image quality of the video.

### SUMMARY OF THE INVENTION

Accordingly, the present invention is mainly a video coding system and circuit emphasizing visual perception, in which a video analysis module is added to a video coding system that compatible with the existing video standards, and the video analysis module analyzes video frames subjected to a coding process to obtain the part perceptible by human eyes, so as to perform a more efficient compression and maintain good image quality of the compressed video frames.

The present invention is also a video coding system and circuit emphasizing visual perception, in which a video analysis module is added without changing the architecture design of the original video coding system, so that the difficulty of integration of the system is greatly reduced, and the hardware circuit architecture can be easily implemented, thereby reducing the development cost and improving the coding efficiency as well.

The present invention is further a video coding system and circuit emphasizing visual perception, in which a video analysis module performs an analysis of the part perceptible by human eyes on an input video frame and/or video-related information generated in coding to generate a quantization parameter adjustment value which is used for adjusting coding parameters of a video coding module, and a coding of the video frame is conducted based on the adjusted coding parameters, thereby achieving a good compression efficiency.

To achieve the above objectives, the present invention provides a video coding system emphasizing visual perception, which comprises: a video coding module, for receiving an input video frame, transforming the input video frame to obtain a plurality of transform coefficients, quantizing each of the transform coefficients according to a plurality of preset quantization values to generate a plurality of quantized coefficients, and coding each of the quantized coefficients to output an image stream; and a video analysis module, connected to the video coding module, for receiving and analyzing the input video frame to generate a quantization parameter adjustment value, and transferring the quantization parameter adjustment value to the video coding module. The video coding module adjusts each of the quantization values according to the quantization parameter adjustment value, and quantizes each of the transform coefficients with each of the adjusted quantization values to generate the quantized coefficients.

The present invention also provides a video coding circuit emphasizing visual perception, which comprises: a video analyzer, for receiving and analyzing an input video frame to generate a quantization parameter adjustment value; and a video coder, connected to the video analyzer, for receiving the input video frame and the quantization parameter adjustment value, and adjusting at least a coding parameter according to the quantization parameter adjustment value, so as to code the input video frame to output an image stream.

The present invention further provides a video coding circuit emphasizing visual perception, which comprises: a first part video coder, for receiving an input video frame, storing a reconstructed video frame, estimating a displacement amount between the input video frame and the reconstructed video frame to generate a motion vector; a video analyzer, connected to the first part video coder, for receiving the input video frame, the reconstructed video frame, and/or the motion vector, performing a visual perception analysis on the input video frame, the reconstructed video frame, and/or the motion vector to generate a quantization parameter adjustment value; a second part video coder, for receiving the input video frame and the quantization parameter adjustment value to adjust at least a coding parameter according to the quantization parameter adjustment value, so as to code the input video frame to generate a plurality of quantized coefficients; and a third part video coder, for inverse-transforming/inverse-quantizing the quantized coefficients to generate the reconstructed video frame, and coding and compressing the quantized coefficients to output an image stream.

### BRIEF DESCRIPTION OF THE DRAWINGS

The present invention will become more fully understood from the detailed description given herein below for illustration only, and thus are not limitative of the present invention, and wherein:

FIG. 1 is a functional block diagram of a video coding system according to a preferred embodiment of the present invention;

FIG. 2 is a functional block diagram of a video analysis module according to a preferred embodiment of the present invention;

FIG. 3 is a schematic block diagram of circuit architecture of the video coding system according to a preferred embodiment of the present invention; and

FIG. 4 is a block diagram of circuit architecture of the video coding system according to another embodiment of the present invention.

### DETAILED DESCRIPTION OF THE INVENTION

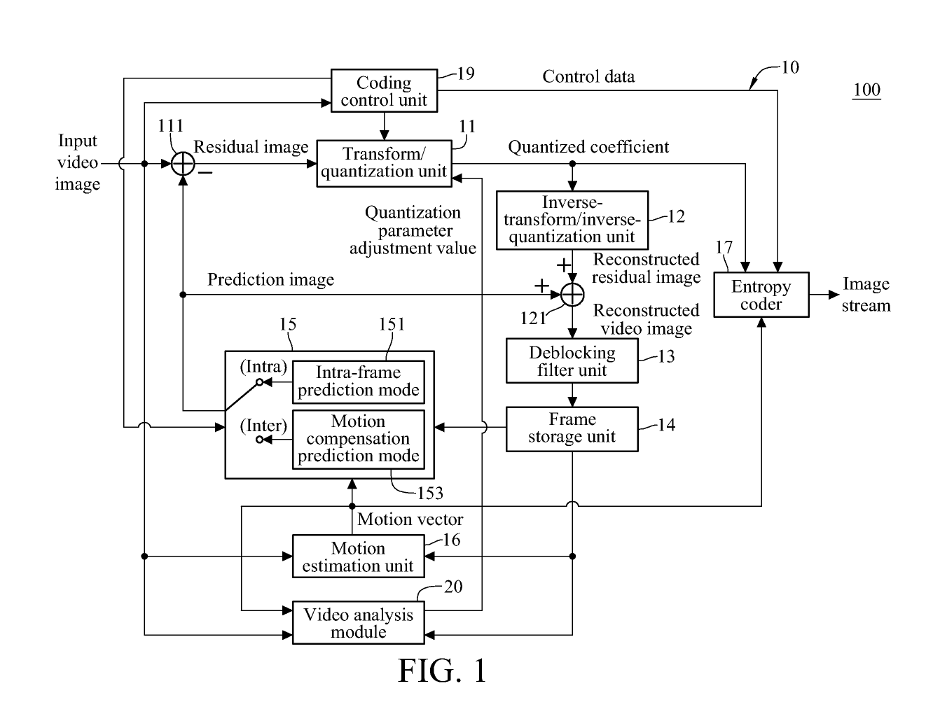

FIG. 1 is a functional block diagram of a video coding system according to a preferred embodiment of the present invention. Referring to FIG. 1, the video coding system 100 is a coding system compatible with the H.264/AVC (Advanced Video Coding) standard, and comprises a video coding module 10 and a video analysis module 20. A video frame is input into the video coding module 10 and the video analysis module 20, and a frame of the video is divided into a plurality of macro blocks with a size such as 4*4, 8*8, or 16*16.

The video coding module 10 transforms the input video frame into a plurality of transform coefficients, quantizes each of the transform coefficients according to a plurality of preset quantization values to generate a plurality of quantized coefficients, and codes each of the quantized coefficients to output an image stream. In this manner, the video coding module 10 performs a coding process on block-based video frames one by one. The video analysis module 20 is connected to the video coding module 10, for analyzing the part of the input video frame that is perceptible by human eyes to generate a quantization parameter adjustment value, and transferring the quantization parameter adjustment value to the video coding module 10. The video coding module 10 adjusts each of the quantization values Q according to the quantization parameter adjustment value, and quantizes each of the transform coefficients with each of the adjusted quantization values to generate the quantized coefficients.

After adding the video analysis module 20 to the video coding system 100 compatible with the existing video standards, the video analysis module 20 analyzes the part perceptible by the human eyes from the video frame subjected to a coding process, so as to perform a more efficient coding compression and maintain good image quality of the compressed video frame.

In addition, the video coding module 10 comprises a transform/quantization unit 11, an inverse-transform/inverse-quantization unit 12, a deblocking filter unit 13, a frame storage unit 14, a prediction unit 15, and a motion estimation unit 16.

The prediction unit 15 is used for predicting a currently input video frame to generate a prediction frame. The currently input video frame and the prediction frame are subjected to comparison and subtraction in an adder 111 to generate a residual image, and the residual image is an incorrect error image of the video frame predicted by the prediction unit 15.

The transform/quantization unit 11 is connected to the prediction unit 15 through the adder 111 to receive the residual image. The transform/quantization unit 11 performs a transform, e.g., a DCT (Discrete Cosine Transform) on the residual image to transform the residual image originally in a space domain into two-dimensional transform coefficients in a frequency domain. After that, the transform/quantization unit 11 performs a quantization process on the transform coefficients according to the set quantization values Q to generate a plurality of quantized coefficients. The greater the quantization values Q are set, the less the important coefficients after quantization are kept, and the compression ratio is high, which, however, may also influence the image quality after decoding. On the contrary, the smaller the quantization values Q are set, the more the important coefficients after quantization are kept, and the image quality after decoding is normally good, which, however, causes an unsatisfactory compression effect. Therefore, the manner of finding proper quantization values Q needs to be further analyzed and adjusted by the video analysis module 20 in the following content, which will be described later. Moreover, as the transform coefficients of the high-frequency part are smaller than the transform coefficients of the low-frequency part, and the human eyes are less sensitive to the high-frequency part than to the low-frequency part, the transform/quantization unit 11 may quantize the transform coefficients of the high-frequency part to be 0 in advance.

The inverse-transform/inverse-quantization unit 12 is connected to the transform/quantization unit 11 to inverse-transform and inverse-quantize (e.g., perform IDCT (inverse Discrete Cosine Transform) and IQ on) the quantized coefficients to generate a reconstructed residual image. After that, the reconstructed residual image and the prediction image are added in another adder 121 to generate a reconstructed video frame.

The deblocking filter unit 13 is connected to the inverse-transform/inverse-quantization unit 12 and the prediction unit 15 through the adder 121 to receive the reconstructed video frame obtained by the adder 121. As the video coding system 100 performs a coding process on the video frame in a block-based manner, the coded video frame always has an inharmonious or oblique block effect, and the deblocking filter unit 13 filters the block effect of the reconstructed video frame.

Then, the frame storage unit 14 is connected to the deblocking filter unit 13 and the preset unit 15 to store the reconstructed video frame completed in each coding. The deblocking filter unit 13 filters the block effect of the reconstructed video frame to obtain a good image visual effect, and the reconstructed video frame is further input into the prediction unit 15 as the reference frame for prediction. Moreover, the frame storage unit 14 may store a plurality of frames of the video at the same time, and each frame is composed of a plurality of macro blocks of the reconstructed video frame.

The motion estimation unit 16 is connected to the frame storage unit 14 and the prediction unit 15, and compares the currently input video frame with the reconstructed video frame (the previously input video frame) by reference to estimate a displacement amount of the currently input video frame relative to the reconstructed video frame, so as to generate a motion vector.

Additionally, the prediction unit 15 comprises two prediction modes, namely, an intra-frame prediction mode 151 and a motion compensation prediction mode 153. When the prediction unit 15 performs prediction on the current video frame, the video coder 10 selects one of the two modes to carry out the prediction.

The intra-frame prediction mode 151 is a spatial prediction. In this mode, the pixel values in the macro blocks of the prediction image are predicted by means of fitting the adjacent coded pixels in the same frame with different prediction directions (e.g., a 4*4 block has 9 different prediction directions and a 16*16 block has 4 different prediction directions) for each macro block of the prediction image, thereby predicting and generating the prediction image, and the minimal rate-distortion cost obtained after coding may be used to determine a preferred prediction direction among others.

As compared with the intra-frame prediction mode 151 that performs prediction with reference to the same frame of the video frame, the motion compensation prediction mode 153 performs prediction of the macro blocks of the currently input video frame with reference to multiple frames of the video frame. The motion compensation prediction mode 153 may also be referred to as the inter-frame prediction which is a temporal prediction, in which a prediction of each of the macro blocks in the currently input video frame is carried out by using multiple frames of the reconstructed video frame stored in the frame storage unit 14 such as several preceding frames of the video frame and/or several following frames of the video frame, the most similar or matching macro blocks are searched from multiple reference frames in cooperation with the motion vectors generated by the motion estimating unit 16, and then the searched macro blocks serve as the prediction images. Furthermore, when a first video frame is input, as the frame storage unit 14 does not store other video frames, the first input video frame can only adopt the intra-frame prediction mode 151.

Additionally, the video coding module 10 further comprises an entropy coder 17 and a coding control unit 19. The entropy coder 17 may perform a variable length coding (VLC), a Huffman coding, a context adaptive variable length coding (CAVLC), or a context-based adaptive binary arithmetic coding (CABAC) or the like, and is connected to the transform/quantization unit 11 and the motion estimating unit 16 to compress and code the quantized coefficients and the motion vector into an image stream. The coding control unit 19 is connected to the transform/quantization unit 11, the entropy coder 17, and the prediction unit 15, for receiving the input video frame, controlling a coding data rate of the transform/quantization unit 11 and the prediction mode of the prediction unit 15, and transferring relevant control data to the entropy coder 17 to be coded in the image stream.

In an embodiment of the present invention, the video analysis module 20 is connected to the transform/quantization unit 11 to transfer the quantization parameter adjustment value generated during the analysis of the input video frame to the transform/quantization unit 11, and the transform/quantization unit 11 adjusts the quantization values Q according to the quantization parameter adjustment value. Or, in another embodiment of the present invention, in addition to being connected to the transform/quantization unit 11, the video analysis module 20 may be further connected to the motion estimating unit 16 and/or the frame storage unit 14, so that the video analysis module 20 can receive and analyze information content such as the input video frame, the reconstructed video frame, and/or the motion vector to generate the quantization parameter adjustment value.

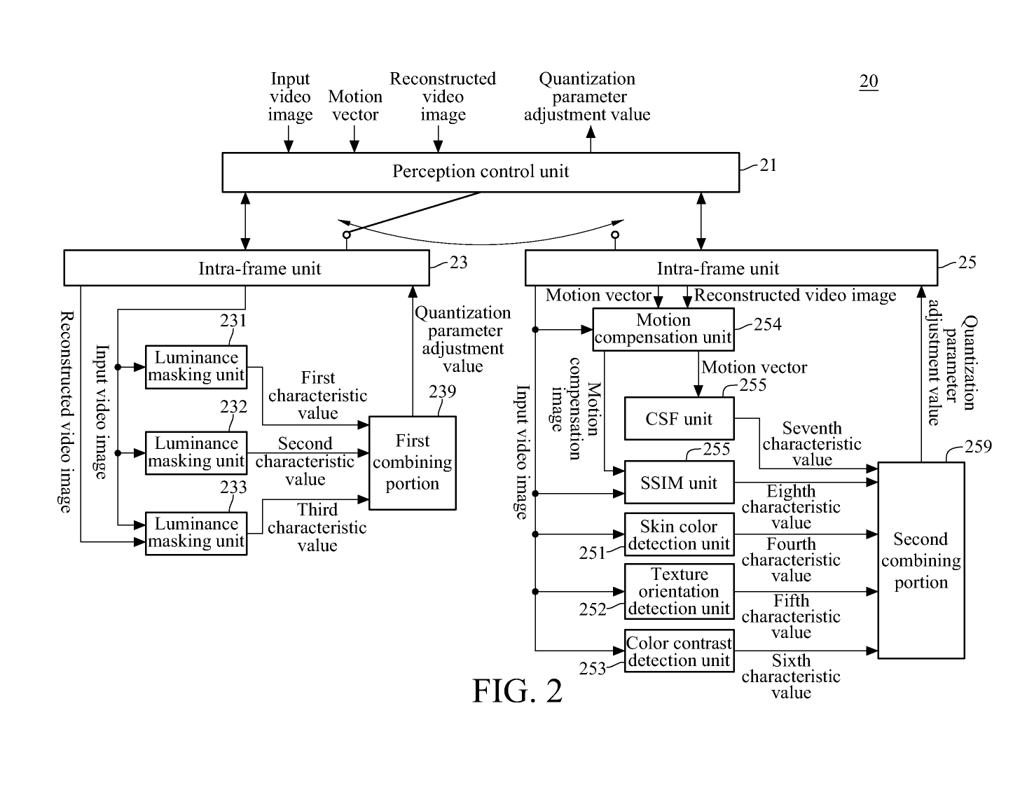

FIG. 2 is a functional block diagram of the video analysis module according to a preferred embodiment of the present invention. Referring to FIG. 2, the H.264 video coding system comprises two frame coding forms, namely, intra-frame coding and inter-frame coding. The video analysis module 20 of the present invention analyzes the two frame coding forms respectively, thereby adjusting the coding parameters of the video coding module 10.

As shown in the figure, the video analysis module 20 comprises a perception control unit 21, an intra-frame unit 23, and an inter-frame unit 25. The perception control unit 21 receives the input video frame, the motion vector, and the reconstructed video frame, and selects the intra-frame unit 23 or the inter-frame unit 25 to analyze the relevant information content of the video frames and further generate a quantization parameter adjustment value. In addition, the unit 23 or 25 selected by the perception control unit 21 may also be determined by the prediction mode selected by the prediction unit 15. If the prediction unit 15 adopts the intra-frame prediction mode 151 to predict the currently input video frame, the perception control unit 21 selects the intra-frame unit 23 to analyze the relevant information content of the video frame. On the contrary, if the prediction unit 15 adopts the motion compensation prediction mode 153 to predict the currently input video frame, the perception control unit 21 selects the inter-frame unit 25 to analyze the relevant information content of the video frame.

The intra-frame unit 23 is mainly used for analyzing static video frame frames (e.g., I-frames), and the analysis result has the JND characteristic. The intra-frame unit 23 receives the currently input video frame and/or the reconstucted video frame through the perception control unit 21, and comprises a luminance masking unit 231, a texture masking unit 232, and/or a temporal masking unit 233.

The luminance masking unit 231 receives the currently input video frame, and analyzes the luminance intensity of surrounding neighboring pixels in one frame of the macro blocks of the currently input video frame. If the surrounding neighboring pixels of the macro blocks of the video frame have high luminance intensity, a first characteristic value that allows a large range of pixel content errors may be generated according to the fact that the visual sensitivity of human eyes is poor under the high luminance. After that, the video coding module 10 performs a lossy coding with a high compression ratio on the currently input video frame. On the contrary, under the circumstance that the surrounding neighboring pixels of the macro blocks of the video frame have low luminance intensity, a first characteristic value with a small range of pixel content errors is generated. Then, the video coding module 10 performs a lossy coding with a low compression ratio or a lossless coding on the currently input video frame.

The texture masking unit 232 receives the input video frame, and analyzes a texture intensity of the surrounding neighboring pixels in one frame of the macro blocks of the currently input video frame. If the surrounding neighboring pixels of the macro blocks of the video frame have a high texture, a second characteristic value that allows a large range of pixel content errors may be generated according to the fact that the visual sensitivity of human eyes is poor under the high texture. After that, the video coding module 10 performs a lossy coding with a high compression ratio on the currently input video frame. On the contrary, under the circumstance that the surrounding neighboring pixels of the macro blocks of the video frame have a low texture, a second characteristic value with a small range of pixel content errors is generated. Then, the video coding module 10 performs a lossy coding with a low compression ratio or a lossless coding on the currently input video frame.

The temporal masking unit 233 receives the input video frame and the rebuilt video frame, and analyzes and compares a pixel variation between the currently input video frame and the reconstructed video frame. If the pixel variation between the two images is large, it indicates that a dynamic displacement exists between the currently input video frame and the reconstructed video frame, and then a third characteristic value that allows a large range of pixel content errors is generated according to the fact that the visual sensitivity of human eyes is poor for dynamic images. After that, the video coding module 10 performs a lossy coding with a high compression ratio on the currently input video frame. On the contrary, if the pixel content of the two images is almost the same, a third characteristic value with a small range of pixel content errors is generated. Then, the video coding module 10 performs a lossy coding with a low compression ratio or a lossless coding on the currently input video frame.

Additionally, the intra-frame unit 23 further comprises a first combining portion 239, connected to the luminance masking unit 231, the texture masking unit 232, and/or the temporal masking unit 233, for combining the first characteristic value, the second characteristic value, and/or the third characteristic value into the quantization parameter adjustment value, and transferring the quantization parameter adjustment value to the transform/quantization unit 11 of the video coding module 10 through the intra-frame unit 23 and the perception control unit 21. The transform/quantization unit 11 selects at least one of the characteristic values or all the three characteristic values from the quantization parameter adjustment value to re-adjust each of the quantization values Q, and quantizes each of the transform coefficients obtained by the DCT with each of the adjusted quantization values Q, thereby obtaining all the quantized coefficients with human visual perception consideration.

Moreover, the inter-frame unit 25 is mainly used for analyzing dynamic video frame frames (e.g., P-Frames, B-Frames). The inter-frame unit 25 receives the currently input video frame through the perception control unit 21, and comprises a skin color detection unit 251, a texture orientation detection unit 252, and/or a color contrast detection unit 253.

The skin color detection unit 251 receives the currently input video frame, and analyzes whether the pixel color of the currently input video frame is the skin color. Since the human eyes are more sensitive to human faces or other skin areas, if the pixel color is not the skin color, a fourth characteristic value that allows a large range of pixel content errors is generated. After that, the video coding module 10 performs a lossy coding with a high compression ratio on the currently input video frame. On the contrary, if the pixel color is the skin color, a fourth characteristic value with a small range of pixel content errors is generated. Then, the video coding module 10 performs a lossy coding with a low compression ratio or a lossless coding on the currently input video frame.

The texture orientation detection unit 252 receives the currently input video frame, and analyzes whether the input video frame contains the orientation image content, e.g., an object contour. If the input video frame does not contain the orientation image content, a fifth characteristic value that allows a large range of pixel content errors is generated. After that, the video coding module 10 performs a lossy coding with a high compression ratio on the currently input video frame. On the contrary, if the orientation image content exists in the currently input video frame, a fifth characteristic value with a small range of pixel content errors is generated. Afterwards, the video coding module 10 performs a lossy coding with a low compression ratio or a lossless coding on the currently input video frame.

The color contrast detection unit 253 receives the currently input video frame, and analyzes whether the input video frame contains the image content having a high color contrast. If the input video frame does not contain the image content having the apparent color contrast, a sixth characteristic value that allows a large range of pixel content errors is generated. After that, the video coding module 10 performs a lossy coding with a high compression ratio on the currently input video frame. On the contrary, if the image content having the apparent color difference exists in the currently input video frame, a sixth characteristic value with a small range of pixel content errors is generated. Then, the video coding module 10 performs a lossy coding with a low compression ratio or a lossless coding on the currently input video frame.

Additionally, the inter-frame unit 25 comprises a second combining portion 259, connected to the skin color detection unit 251, the texture orientation detection unit 252, and/or the color contrast detection unit 253, for combining the fourth characteristic value, the fifth characteristic value, and/or the sixth characteristic value into the quantization parameter adjustment value, and transferring the quantization parameter adjustment value to the transform/quantization unit 11 of the video coding module 10 through the inter-frame unit 25 and the perception control unit 21.

Moreover, in addition to receiving the input video frame, the inter-frame unit 25 may further receive the reconstructed video frame and/or the motion vector through the perception control unit 21, and comprises a motion compensation unit 254, a contrast sensitivity function (CSF) unit 255, and/or a structural similarity index evaluation (SSIM) unit 256.

The operations of the motion compensation unit 254 are similar to the above motion compensation prediction mode 153. The macro blocks of the currently input video frame search the coded reconstructed video frame (the previous frame of the video frame) for the most similar or matching macro blocks by using the motion vector. Then, the searched macro blocks serve as a motion compensation image. The motion compensation image is similar to the prediction image predicted by the motion compensation prediction mode 153, and the size of the macro blocks of the motion compensation image is equal to that of the macro blocks of the currently input video frame, such as 4*4, 8*8, or 16*16.

The CSF unit 255 receives the motion vector, and analyzes the displacement of the motion vector. If a displacement speed of the motion vector exceeds a preset value, a seventh characteristic value that allows a large range of pixel content errors is generated according to the fact that the visual sensitivity of human eyes is poor for the video frame with the high displacement speed. After that, a lossy coding with a high compression ratio is performed on the currently input video frame. On the contrary, if the displacement speed of the motion vector does not exceed the preset value, a seventh characteristic value with a small range of pixel content errors is generated. Then, a lossy coding with a low compression ratio can be performed on the currently input video frame.

The SSIM unit 256 receives the currently input video frame and the motion compensation image, and compares the structural content of the two images. If the structural content of the two is similar, an eighth characteristic value that allows a large range of pixel content errors is generated. After that, the video coding module 10 points out that the currently input video frame is almost the same as the coded motion compensation image (one of the macro blocks in the previous frame of the video frame) in visual aspect by using the characteristic value. Therefore, a lossy coding with a high compression ratio may be performed on the currently input video frame, so as to reduce the coding bits. On the contrary, if the structural content of the two is quite different, an eighth characteristic value with a small range of pixel content errors is generated. Then, the video coding module 10 performs a lossy coding with a low compression ratio on the currently input video coding.

After that, the second combining portion 259 further combines the seventh characteristic value and the eighth characteristic value in the quantization parameter adjustment value, and transfers the quantization parameter adjustment value to the transform/quantization unit 11 of the video coding module 10 through the inter-frame unit 25 and the perception control unit 21. The transform/quantization unit 11 selects at least one of the characteristic values or all of the five characteristic values from the quantization parameter adjustment value to re-adjust all the quantization values Q, and quantizes each of the transform coefficients obtained by the DCT transform with each of the adjusted quantization values Q, thereby obtaining all the quantized coefficients with human visual perception consideration.

Accordingly, the transform/quantization unit 11 adjusts and quantizes all the quantization values Q of the transform coefficients with the quantization parameter adjustment value generated by the intra-frame unit 23 or the inter-frame unit 25, so as to obtain all the quantized coefficients. After that, the entropy coder 17 codes the quantized coefficients that take the human visual perception into consideration, so as to obtain the efficient coding compression and the image stream with low bit rate and maintain good image quality of the compressed video frame.

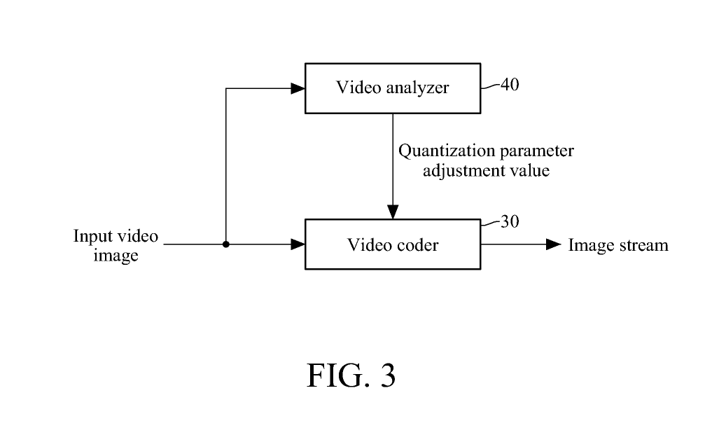

FIG. 3 is a schematic block diagram of circuit architecture of the video coding system according to a preferred embodiment of the present invention. Referring to FIG. 3 together with FIGS. 1 and 2, the circuit architecture of the video coding system mainly comprises two parts, namely, a video coder 30 and a video analyzer 40. The video coder 30 is electrically connected to the video analyzer 40.

The circuit of the video coder 30 comprises the function architecture of the video coding module 10 in FIG. 1, and the video analyzer 40 comprises the function architecture of the video analysis module 20 in FIG. 2. A video frame is input into the video coder 30 and the video analyzer 40. The video analyzer 40 carries out several types of visual perception analysis, such as the luminance, texture, skin color, orientation image content, or color contrast analysis on the input video frame, to generate a quantization parameter adjustment value.

The video coder 30 receives the quantization parameter adjustment value and adjusts at least a coding parameter, e.g., quantization values Q, according to the quantization parameter adjustment value, so as to compress and code the currently input video frame according to the coding parameters taking the human visual perception into consideration to output an image stream.

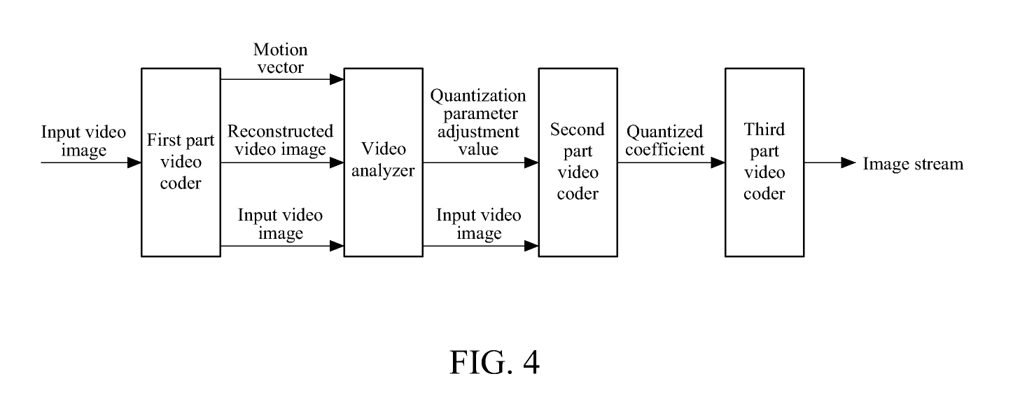

In addition, FIG. 4 is a block diagram of circuit architecture of the video coding system according to another embodiment of the present invention. Referring to FIG. 4 together with FIGS. 1 and 2, the circuit architecture of the video coding system mainly comprises four parts, namely, a first part video coder 51, a video analyzer 60, a second part video coder 52, and a third part video coder 53. The four parts are electrically connected in sequence.

The first part video coder 51 comprises the function architecture of the frame storage unit 14 and the motion estimation unit 16 of the video coding module 10 in FIG. 1. The first part video coder 51 stores at least a reconstructed video frame (the previously input video frame), and compares the input video frame with the reconstructed video frame to estimate a displacement amount of the currently input video frame, so as to generate a motion vector.

The video analyzer 60 comprises complete function architecture of the video analysis module 20 in FIG. 2, and receives the motion vector, the reconstructed video frame, and the currently input video frame. The video analyzer 60 adopts the intra-frame unit 23 or the inter-frame unit 25 to carry out several types of visual perception analysis, e.g., the luminance, texture, temporal, CSF, SSIM, skin color, texture orientation, or color contrast analysis on the information content such as the rebuilt video frame and/or the motion vector of the currently input video frame, to generate a quantization parameter adjustment value.

The second part video coder 52 comprises the function architecture of the transform/quantization unit 11 and the prediction unit 15 of the video coding module 10 in FIG. 1 and/or the frame storage unit 14 and a part of the motion estimation unit 16. The second part video coder 52 receives the quantization parameter adjustment value and the input video frame, and adjusts at least a coding parameter, e.g., the quantization values Q, according to the quantization parameter adjustment value, so as to compress and code the currently input video frame according to the coding parameters taking human visual perception into consideration, thereby generating a plurality of quantized coefficients.

The third part video coder 53 comprises the function architecture of the inverse-transform/inverse-quantization unit 11, the deblocking filter unit, and the entropy coder 17 of the video coding module 10 in FIG. 1. The third part video coder 53 receives each of the quantized coefficients, and inverse-transforms/inverse-quantizes all the quantized coefficients into a reconstructed video frame. After that, the reconstructed video frame is subjected to a block effect filter process so as to be stored in the first part video coder 51, and at the same time, the third part video coder 53 compresses and codes each of the quantized coefficients to output an image stream.

In the circuit architecture in FIGS. 3 and 4, a visual perception-based video analysis function is added without changing the circuit design of the original video coding system, so the difficulty in integration of the system is reduced. In this manner, the hardware circuit architecture can be easily realized, the development cost is lowered, and the coding efficiency of the video coding system is improved.

What is claimed is:

1. A video coding system emphasizing visual perception, comprising:
a video coding module, for receiving an input video frame, transforming the input video frame to obtain a plurality of transform coefficients, quantizing each of the transform coefficients according to a plurality of preset quantization values to generate a plurality of quantized coefficients, and coding each of the quantized coefficients to output an image stream; and
a video analysis module, connected to the video coding module, for receiving and analyzing the input video frame to generate a quantization parameter adjustment value, and transferring the quantization parameter adjustment value to the video coding module,
wherein the video coding module adjusts each of the quantization values according to the quantization parameter adjustment value and quantizes each of the transform coefficients with each of the adjusted quantization values to generate the quantized coefficients.

2. The video coding system according to claim 1, wherein the video coding module comprises:
a prediction unit, for predicting the input video frame to generate a prediction image;
a transform/quantization unit, connected to the prediction unit, for receiving a residual image obtained by subtraction between the video frame and the prediction image, transforming the residual image into the transform coefficients, and quantizing each of the transform coefficients with each of the quantization values to generate the quantized coefficients;
an inverse-transform/inverse-quantization unit, connected to the transform/quantization unit, for inverse-transforming and inverse-quantizing the quantized coefficients to generate a reconstructed residual image;
a deblocking filter unit, connected to the inverse-transform/inverse-quantization unit and the prediction unit, for receiving a reconstructed video frame obtained by adding the reconstructed residual image and the prediction image;
a frame storage unit, connected to the deblocking filter unit and the prediction unit, for storing the reconstructed video frame and transferring the rebuilt video frame to the prediction unit;
a motion estimation unit, connected to the frame storage unit and the prediction unit, for estimating a motion vector according to the input video frame and the reconstructed video frame and inputting the motion vector to the prediction unit; and
an entropy coder, connected to the transform/quantization unit and the motion estimation unit, for receiving the quantized coefficients and the motion vector to code and generate the image stream.

3. The video coding system according to claim 2, further comprising a coding control unit, connected to the transform/quantization unit, the entropy coder, and the prediction unit, for receiving the input video frame, controlling a coding data rate of the transform/quantization unit and a prediction mode of the prediction unit, and transferring relevant control data to the entropy coder to be coded in the image stream.

4. The video coding system according to claim 2, wherein the video analysis module is connected to the transform/quantization unit, for receiving and analyzing the input video frame to generate the quantization parameter adjustment value, and transferring the quantization parameter adjustment value to the transform/quantization unit.

5. The video coding system according to claim 2, wherein the video analysis module is connected to the transform/quantization unit, the frame storage unit, and/or the motion estimating unit, for receiving and analyzing data content containing the input video frame, the reconstructed video frame, and/or the motion vector to generate the quantization parameter adjustment value, and transferring the quantization parameter adjustment value to the transform/quantization unit.

6. The video coding system according to claim 2, wherein the prediction unit comprises an intra-frame prediction mode and a motion compensation prediction mode, and the preset unit selects one of the two modes to perform prediction of the input video frame to generate the prediction image.

7. The video coding system according to claim 6, wherein the video analysis module comprises:
a perception control unit, for receiving the data content containing the input video frame, the reconstructed video frame, and/or the motion vector to output the quantization parameter adjustment value;
an intra-frame unit, connected to the perception control unit, for analyzing the input video frame and/or the reconstructed video frame to generate the quantization parameter adjustment value, and transferring the quantization parameter adjustment value to the perception control unit; and
an inter-frame unit, connected to the perception control unit, for analyzing the input video frame, the reconstructed video frame, and/or the motion vector to generate the quantization parameter adjustment value, and transferring the quantization parameter adjustment value to the perception control unit,
wherein if the prediction unit selects the intra-frame prediction mode to predict the input video frame, the perception control unit selects the intra-frame unit to perform a visual perception analysis, and if the prediction unit selects the motion compensation prediction mode to predict the input video frame, the perception control unit selects the inter-frame unit to perform a visual perception analysis.

8. The video coding system according to claim 7, wherein the intra-frame unit comprises:
a luminance masking unit, for analyzing a luminance intensity of the input video frame to generate a first characteristic value;
a texture masking unit, for analyzing a texture intensity of the input video frame to generate a second characteristic value; and
a first combining portion, connected to the luminance masking unit and the texture masking unit, for combining the first characteristic value and the second characteristic value in the quantization parameter adjustment value, and transferring the quantization parameter adjustment value to the transform/quantization unit of the video coding module through the perception control unit.

9. The video coding system according to claim 8, wherein the intra-frame unit further comprises a temporal masking unit, for analyzing and comparing a pixel variation of the input video frame and the reconstructed video frame to analyze if a dynamic displacement of the input video frame exists to generate a third characteristic value, and the first combining portion is connected to the temporal masking unit to combine the third characteristic value in the quantization parameter adjustment value.

10. The video coding system according to claim 7, wherein the inter-frame unit comprises:
a skin color detection unit, for analyzing whether a pixel color of the input video frame is a skin color to generate a fourth characteristic value;
a texture orientation detection unit, for analyzing whether the input video frame contains orientated image content to generate a fifth characteristic value;
a color contrast detection unit, for analyzing whether the input video frame contains image content having a great color contrast to generate a sixth characteristic value; and
a second combining portion, for connecting the skin color detection unit, the texture orientation detection unit, and the color contrast detection unit, combining the fourth characteristic value, the fifth characteristic value, and the sixth characteristic value in the quantization parameter adjustment value, and transferring the quantization parameter adjustment value to the transform/quantization unit of the video coding module through the perception control unit.

11. The video coding system according to claim 10, wherein the inter-frame unit further comprises:
a motion compensation unit, for receiving the input video frame, the reconstructed video frame, and the motion vector, and searching the reconstructed video frame for a macro block similar to the input video frame by using the motion vector to generate a motion compensation image;
a contrast sensitivity function (C SF) unit, for analyzing whether a displacement amount of the motion vector exceeds a rating value to generate a seventh characteristic value; and
a structural similarity index evaluation (SSIM) unit, for comparing structural content similarities of the input video frame and the motion compensation image to generate an eighth characteristic value,
wherein the second combining portion is connected to the CSF unit and the SSIM unit to combine the seventh characteristic value and the eighth characteristic value in the quantization parameter adjustment value.

12. A video coding circuit emphasizing visual perception, comprising:
a video analyzer, for receiving and analyzing an input video frame to generate a quantization parameter adjustment value; and
a video coder, connected to the video analyzer, for receiving the input video frame and the quantization parameter adjustment value, and adjusting at least a coding parameter according to the quantization parameter adjustment value, so as to code the input video frame to output an image stream.

13. A video coding circuit emphasizing visual perception, comprising:
a first part video coder, for receiving an input video frame, storing a reconstructed video frame, estimating a displacement amount between the input video frame and the reconstructed video frame to generate a motion vector;
a video analyzer, connected to the first part video coder, for receiving the input video frame, the reconstructed video frame, and/or the motion vector, and performing a visual perception analysis on the input video frame, the reconstructed video frame, and/or the motion vector to generate a quantization parameter adjustment value;
a second part video coder, for receiving the input video frame and the quantization parameter adjustment value to adjust at least a coding parameter according to the quantization parameter adjustment value, and coding the input video frame to generate a plurality of quantized coefficients; and
a third part video coder, for inverse-transforming/inverse-quantizing the quantized coefficients to generate the reconstructed video frame, and coding and compressing the quantized coefficients to output an image stream.
